(19) United States
(12) Patent Application Publication
(10) Pub. No.: US 2011/0244271 A1
(43) Pub. Date: Oct. 6, 2011

(54) HEXAGONAL FERRITE MAGNETIC POWDER AND METHOD OF MANUFACTURING THE SAME, AND MAGNETIC RECORDING MEDIUM

(75) Inventor: Takeshi KAKUTA, Minami-ashigara-shi (JP)

(73) Assignee: FUJIFILM Corporation, Tokyo (JP)

(21) Appl. No.: 13/077,300

(22) Filed: Mar. 31, 2011

(30) Foreign Application Priority Data
Mar. 31, 2010 (JP) 2010-083445

(51) Int. Cl. G11B 5/706; C01G 49/02

(52) U.S. Cl. 428/842.4; 423/633

(57) ABSTRACT

An aspect of the present invention relates to a method of manufacturing a hexagonal ferrite magnetic powder comprising discharging a melt of a starting material mixture comprising a glass-forming component and a hexagonal ferrite-forming component through an outlet provided in the bottom surface of the melting vat and supplying it between a pair of rotating milling rolls positioned beneath the melting vat; discharging an amorphous material from between the rolls by roll quenching the melt that has been supplied between the milling rolls, wherein at least an outermost layer portion of the milling rolls is comprised of a material with a Young's modulus of 500 GPa or higher and a Rockwell hardness of 85.0 HRA or higher, and the outermost layer portion has a thickness of 5 mm or greater and a surface roughness of 0.5 μm or less.

### CROSS-REFERENCE TO RELATED APPLICATIONS

This application claims the benefit of priority under 35 USC 119 to Japanese Patent Application No. 2010-083445, filed on Mar. 31, 2010, which is expressly incorporated herein by reference in its entirety.

### BACKGROUND OF THE INVENTION

1. Field of the Invention

The present invention relates to a method of manufacturing a hexagonal ferrite magnetic powder, and more particularly, to a method of manufacturing a hexagonal ferrite magnetic powder that is suitable as the magnetic powder of a magnetic recording medium for high-density recording.

The present invention further relates to a hexagonal ferrite magnetic powder obtained by the above method, and a particulate magnetic recording medium comprising the above hexagonal ferrite magnetic powder.

2. Discussion of the Background

Recently, ferromagnetic metal powders have come to be primarily employed in the magnetic layers of magnetic recording media for high-density recording. Ferromagnetic metal powders are comprised of acicular particles of mainly iron, and are employed in magnetic recording media for various applications in which minute particle size and high coercive force are required for high-density recording.

With the increase in the quantity of information being recorded, magnetic recording media are required to achieve ever higher recording densities. However, in improving the ferromagnetic metal powder to achieve higher density recording, limits have begun to appear. By contrast, hexagonal ferrite magnetic powders have a coercive force that is high enough for use in permanently magnetic materials. Magnetic anisotropy, which is the basis of coercive force, derives from a crystalline structure. Thus, high coercive force can be maintained even when the particle size is reduced. Further, magnetic recording media employing hexagonal ferrite magnetic powder in the magnetic layers thereof can afford good high-density characteristics due to their vertical components. Thus, hexagonal ferrite magnetic powder is an optimal ferromagnetic material for achieving high density.

For example, Japanese Unexamined Patent Publication (KOKAI) Heisei No. 7-201547 and Japanese Unexamined Patent Publication (KOKAI) No. 2010-24113 or English language family member US2010/0021771A1, which are expressly incorporated herein by reference in their entirety, propose manufacturing the hexagonal ferrite magnetic powders used in magnetic recording by the glass crystallization method.

Recording density has continued to increase in recent years, with a recording density of equal o or higher than 1 Gbpsi currently being targeted. Under these conditions, there is a need to further enhance the magnetic properties of hexagonal ferrite magnetic powder. To that end, it is essential to discover methods of manufacturing hexagonal ferrite magnetic powders with good magnetic properties. Known methods of manufacturing hexagonal ferrite powder include the hydrothermal synthesis method and coprecipitation method in addition to the above glass crystallization method. However, the glass crystallization method is said to be a good method of manufacturing hexagonal ferrite for use in magnetic recording media. It yields a magnetic powder that is suitable in terms of the microparticles and single particle dispersion that are desirable in magnetic recording media, as well as from the perspective of a narrow particle size distribution and the like.

### SUMMARY OF THE INVENTION

An aspect of the present invention provides for a method of manufacturing hexagonal ferrite magnetic powder by the glass crystallization method that permits ultra high-density recording.

The present inventor conducted extensive research into achieving the above hexagonal ferrite magnetic powder, resulting in the following discoveries.

The above publications propose controlling the level of magnetization of an amorphous intermediate in the manufacturing of hexagonal ferrite magnetic powder by the glass crystallization method. In Japanese Unexamined Patent Publication (KOKAI) Heisei No. 7-201547, the considerations are such that when the level of magnetization of the amorphous material exceeds 2 emu/g, a micro-ordered state is generated within the random state of the glass, impeding the formation of uniform crystal nuclei. This then causes the SDFr value of the hexagonal ferrite magnetic powder that is obtained to increase. In Japanese Unexamined Patent Publication (KOKAI) No. 2010-24113, it is described that the level of magnetization (saturation magnetization) of the amorphous material serves as an index of the level of crystallization during precipitation by quenching. Keeping the saturation magnetization of the amorphous material to equal to or lower than 0.6 A·m²/kg is described as yielding hexagonal ferrite magnetic powder with a sharp particle size distribution. That is, the lower the saturation magnetization of the amorphous material serving as intermediate to obtain hexagonal ferrite magnetic powder, the greater the improvement in the physical and magnetic properties of the hexagonal ferrite magnetic powder that is finally obtained.

In this regard, the present inventor reached the conclusion that when quenching of the melt was nonuniform in the course of obtaining an amorphous material, the saturation magnetization of the amorphous material tended to rise. Accordingly, the uniform quenching of the melt was important for obtaining a hexagonal ferrite magnetic powder with good characteristics. Thus, the present inventor conducted further research directed at means of uniformly quenching the amorphous material. This resulted in the discovery that by quenching the melt with milling rolls (dual rolls) in which at least the outermost layer portion was comprised of a material having a Young's modulus of equal to or higher than 500 GPa and a Rockwell hardness of equal to or higher than 85.0 HRA, the thickness of the outermost layer portion was equal to or greater than 5 mm, and the roughness of the outermost layer was equal to or less than 0.5 it was possible to uniformly quench the amorphous material and further increase productivity.

The present invention was devised based on this knowledge.

An aspect of the present invention relates to a method of manufacturing a hexagonal ferrite magnetic powder comprising:

melting in a melting vat a starting material mixture comprising a glass-forming component and a hexagonal ferrite-forming component;

discharging a melt prepared through an outlet provided in the bottom surface of the melting vat and supplying it between a pair of rotating milling rolls positioned beneath the melting vat;

discharging an amorphous material from between the rolls by roll quenching the melt that has been supplied between the milling rolls;

subjecting the amorphous material to heat treatment to cause hexagonal ferrite magnetic particles to precipitate; and

collecting the hexagonal ferrite magnetic particles precipitated from a substance obtained by the heat treatment, wherein

at least an outermost layer portion of the milling rolls is comprised of a material with a Young's modulus of equal to or higher than 500 GPa and a Rockwell hardness of equal to or higher than 85.0 HRA,

the outermost layer portion has a thickness of equal to or greater than 5 mm and

the milling rolls have a surface roughness of equal to or less than 0.5 μm.

The pressure between the milling rolls may range from 0.25 to 1.5 kN/cm.

The peripheral velocity of the milling rolls may range from 10 to 40 m/s.

The diameter of the milling rolls may range from 10 to 50 cm.

The saturation magnetization of the amorphous material discharged from between the rolls may be equal to or greater than 0.3 A·m²/kg.

The amorphous material may be discharged from between the rolls as a thin strip equal to or less than 20 μm in thickness.

The starting material mixture may comprise equal to or higher than 30 molar percent of a Fe₂O₃ component a portion of which may be replaced with a coercive force-adjusting component.

The melt may be discharged through an outlet at a flow rate ranging from 5 to 30 g/s.

The hexagonal ferrite magnetic powder may be a barium ferrite magnetic powder.

A further aspect of the present invention relates to a hexagonal ferrite magnetic powder prepared by the above method.

A still further aspect of the present invention relates to a magnetic recording medium comprising a magnetic layer containing a ferromagnetic powder and a binder on a nonmagnetic support, wherein the ferromagnetic powder comprises the above hexagonal ferrite magnetic powder.

The present invention can provide with high productivity a hexagonal ferrite magnetic powder that is suited to magnetic recording media for ultra high-density recording.

Other exemplary embodiments and advantages of the present invention may be ascertained by reviewing the present disclosure and the accompanying drawing.

### BRIEF DESCRIPTION OF THE DRAWINGS

The present invention will be described in the following text by the exemplary, non-limiting embodiments shown in the figure, wherein:

FIG. 1 is a descriptive drawing showing a schematic of the amorphous rendering step using milling rolls (dual rolls).

FIG. 2 is a descriptive drawing (triangular phase diagram) showing an example of the composition of the starting material mixture.

FIG. 3 is schematics of milling rolls that can be employed in the present invention.

### DETAILED DESCRIPTION OF THE EMBODIMENTS

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description taken with the drawings making apparent to those skilled in the art how several forms of the present invention may be embodied in practice.

### Method of Manufacturing Hexagonal Ferrite Magnetic Powder

The present invention relates to a method of manufacturing a hexagonal ferrite magnetic powder comprising: melting in a melting vat a starting material mixture comprising a glass-forming component and a hexagonal ferrite-forming component; discharging a melt prepared through an outlet provided in the bottom surface of the melting vat and supplying it between a pair of rotating milling rolls (also referred to as “dual rolls” hereinafter) positioned beneath the melting vat; discharging an amorphous material from between the rolls by roll quenching the melt that has been supplied between the milling rolls; subjecting the amorphous material to heat treatment to cause hexagonal ferrite magnetic particles to precipitate; and collecting the hexagonal ferrite magnetic particles precipitated from a substance obtained by the heat treatment. As the milling rolls, those satisfying (A) to (C) below are employed:

(A) at least an outermost layer portion of the milling rolls is comprised of a material with a Young's modulus of equal to or higher than 500 GPa and a Rockwell hardness of equal to or higher than 85.0 HRA;

(B) the outermost layer portion has a thickness of equal to or greater than 5 mm, and

(C) the milling rolls have a surface roughness of equal to or less than 0.5 μm.

The method of manufacturing a hexagonal ferrite magnetic powder of the present invention can yield a hexagonal ferrite magnetic powder by the glass crystallization method. In this context, the method of manufacturing a hexagonal ferrite magnetic powder by the glass crystallization method is generally comprised of the following steps:

(1) a step of obtaining a melt by melting a starting material mixture comprising a glass-forming component and a hexagonal ferrite-forming component (optionally including a coercive force-adjusting component) (melting step);
(2) a step of quenching the melt to obtain an amorphous material (amorphous rendering step);
(3) a step of heat treatment of the amorphous material to induce the precipitation of hexagonal ferrite particles (crystallization step); and
(4) a step of collecting the hexagonal ferrite magnetic particles that have precipitated from the heat treated material (particle collecting step).

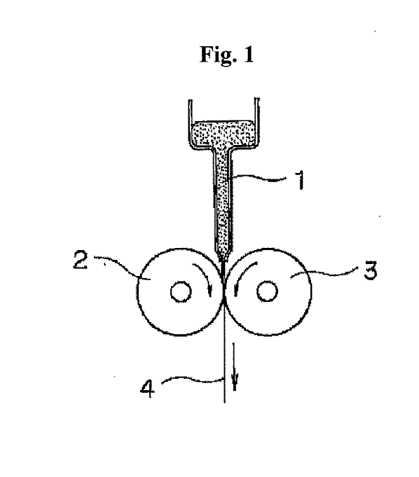

Step (2) is normally conducted by a continuous quenching method employing a single roll or dual rolls in the form of rotating metal members. From the perspectives of quenching efficiency and the like, the use of dual rolls is advantageous. Accordingly, the amorphous rendering step is conducted by supplying and roll quenching the melt of the starting material mixture between a pair of rotating milling rolls (dual rolls) in the present invention. The amorphous rendering step conducted with milling rolls will be described with reference to FIG. 1.

FIG. 1 is a descriptive drawing showing a schematic of the amorphous rendering step employing milling rolls (dual rolls). In the amorphous rendering step, the melt 1 is discharged through an outlet provided in the bottom surface of the melting vat and supplied between a pair of rotating milling rolls 2, 3 positioned beneath the melting vat, being roll quenched between the milling rolls. Since the melt is rendered amorphous by this roll quenching, amorphous material 4 is discharged between the rolls. This step will be further described. Melt 1 with temperature t_{A}° C. is introduced into the area between the two rollers 2, 3 of surface temperature t_{B}° C. that press together while rotating in opposite directions, as indicated by the arrows. Heat of melt 1 is removed between rollers 2 and 3, assuming temperature t_{c}° C. When t_{c} is a temperature adequate to cause the melt to become an amorphous material, melt 1 becomes a solid (amorphous material 4), dropping through the gap between the rollers. To increase the uniformity of quenching at that time, it is desirable for the solidified melt to be rolled thinner between the rolls. This is because the thinner it becomes, the more readily heat on the interior is removed, and the more the cooling differential between the inner and outer portions is reduced. Accordingly, when the present inventor increased the pressure between the milling rolls (also referred to as the “nip pressure”) to roll the melt thinner, contrary to expectation, quenching become nonuniform and the saturation magnetization of the amorphous material obtained increased.

The present inventor attributed this to the following causes. First, when the nip pressure was increased, the outer surface of the rolls become deformed. When this deformation became substantial, the contact area between the roll surface and the solid material increased, and the effective pressure decreased. Second, the higher the nip pressure became, the greater the tendency of the surface of the rolls to develop scratches due to contact with the solid material and the opposite roll became. In scratched portions, roll quenching was not adequately achieved, thereby producing a difference in the degree of cooling in scratched portions and unscratched portions.

Accordingly as a countermeasure to the first cause, the present inventor employed a material with a Young's modulus of equal to or higher than 500 GPa as the material constituting the outermost layer portion of the rolls. As a countermeasure to the second cause, they employed a material with a Rockwell hardness of equal to or higher than 85.0 HRA as the above material. This is because materials that do not have a Young's modulus of equal to or higher than 500 GPa undergo considerable deformation during rolling, and materials that do not have a Rockwell hardness of equal to or higher than 85.0 HRA undergo a reduction in scratch resistance, causing the roll surface to develop multiple scratches during rolling.

As a result of the research conducted by the present inventor, the following two points also became clear:

Even in a milling roll with an outermost layer portion comprised of a material satisfying the above characteristics, there was inadequate durability when the thickness of the outermost layer portion was less than 5 mm, and multiple scratches tended to develop during rolling. Accordingly, it was necessary for the thickness of the portion that was constituted by a material having the above Young's modulus and Rockwell hardness to be equal to or greater than 5 mm.

It was necessary for the surface roughness of a roll having an outermost layer portion satisfying the above characteristics and thickness to be equal to or less than 0.5 μm. The reasons for this were as follows.

When the roll surface was rough and irregularities were present, protrusions dug into the solid material and were cooled in that state. As a result, the amorphous material adhered between the rolls, the discharge efficiency of the amorphous material between the rolls diminished, and productivity decreased. Further, protrusions contacted the solid material and the opposing roll and dropped off, tending to scratch the surface of the roll. Accordingly, it was necessary to employ smooth rolls to inhibit adhesion and scratching of the amorphous material.

As set forth above, in the present invention, the use of milling rolls satisfying (A) to (C) above permits the uniform quenching of the amorphous material. This makes it possible to obtain a hexagonal ferrite magnetic powder having good magnetic properties. Further, it is also possible to achieve greater production stability with the milling rolls because the service lifetime of the rolls increases in milling rolls that are resistant to scratching (durable) in the manner set forth above.

The melting step, amorphous rendering step, crystallization step, and particle collecting step in the method of a manufacturing hexagonal ferrite magnetic powder of the present invention will be sequentially described in greater detail below.

(1) melting step

The starting material mixture employed in the glass crystallization method contains a glass-forming component and a hexagonal ferrite-forming component, and in the present invention, the starting material containing at least the above components are employed. The term “glass-forming component” refers to a component that is capable of exhibiting a glass transition phenomenon to form an amorphous material (vitrify). A B₂O₃ component is normally employed as a glass-forming component in the glass crystallization method. In the present invention, it is possible to employ a starting material mixture containing a B₂O₃ component as the glass-forming component. In the glass crystallization method, the various components contained in the starting material mixture are present in the form of oxides or various salts that can be converted to oxides in a step such as melting. In the present invention, the term “B₂O₃ component” includes B₂O₃ itself and various salts, such as H₃BO₃, that can be changed into B₂O₃ in the process. The same holds true for other components. Examples of glass-forming components other than B₂O₃ components are SiO₂ components, P₂O₅ components, and GeO₂ components.

Metal oxides such as Fe₂O₃, BaO, SrO, and PbO that serve as constituent components of hexagonal ferrite magnetic powder are examples of the hexagonal ferrite-forming component in the starting material mixture. For example, the use of a BaO component as the main component of the hexagonal ferrite-forming component makes it possible to obtain barium ferrite magnetic powder. The content of the hexagonal ferrite-forming component in the starting material mixture can be suitably set based on the desired electromagnetic characteristics.

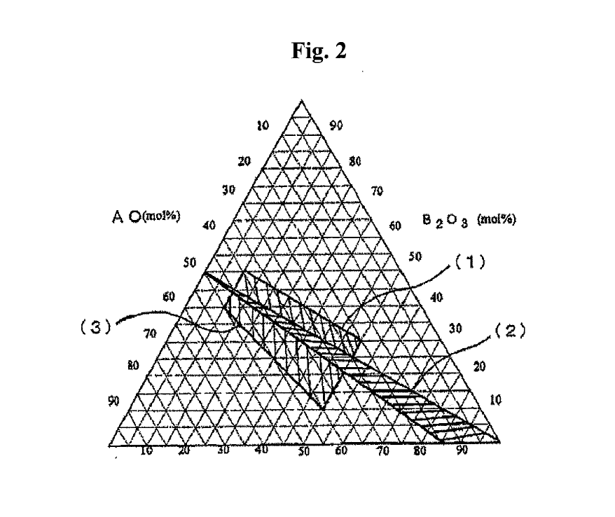

The composition of the starting material mixture is not specifically limited. For example, the starting materials within the composition regions of hatched portions (1) to (3) in the triangular phase diagram shown in FIG. 2, with an AO component (wherein A denotes one or more selected from among Ba, Sr, Ca, and Pb, for example), B₂O₃ component, and Fe₂O₃ component as vertices, are desirable to achieve a high coercive force Hc and saturation magnetization as. The starting materials within the component region (hatched portion (3)) defined by the four points a, b, c, and d below are particularly desirable. As set forth above, a portion of the B₂O₃ component can be replaced with another glass-forming component such as a SiO₂ component or a GeO₂ component. As set forth further below, it is also possible to replace a portion of the Fe₂O₃ component to adjust the coercive force.

(a) B₂O₃=44, AO=46, Fe₂O₃=10 mole percent

(b) B₂O₃=40, AO=50, Fe₂O₃=10 mole percent

(c) B₂O₃=21, AO=29, Fe₂O₃=50 mole percent

(d) B₂O₃=10, AO=40, Fe₂O₃=50 mole percent.

The plate ratio of hexagonal ferrite magnetic powder is desirably low from the perspectives of increasing the fill rate of the magnetic layer and inhibiting an increase in noise due to stacking. The plate ratio tends to decrease when the proportion of hexagonal ferrite forming components in the starting material mixture is increased. Thus, to obtain a hexagonal ferrite magnetic powder with a low plate ratio, it is desirable to employ a starting material mixture in which the proportion of Fe₂O₃ is equal to or higher than 30 molar percent, for example (in which a portion of the Fe₂O₃ component can be replaced with a coercive force-adjusting component, described further below).

However, the higher the proportion of Fe₂O₃ becomes, the harder the mixture of starting materials becomes (and the higher the viscosity of the melt becomes), making it difficult to thin the solid material by rolling between the rolls. It then becomes necessary to increase the pressure between rolls to thin the starting material mixture by rolling in this manner. However, as set forth above, it becomes difficult to uniformly cool the amorphous material when the pressure between rolls is increased with conventional milling rolls. By contrast, in the present invention, uniform quenching of the amorphous material is possible even at a high pressure between rolls, as set forth above. Accordingly, the manufacturing method of the present invention is suitable as a method of obtaining hexagonal ferrite magnetic powder from a starting material mixture that requires a high pressure between rolls for thinning by rolling when the proportion of hexagonal ferrite forming components falls within the above range, for example.

A portion of the Fe can be replaced with other metal elements to adjust the coercive force of the hexagonal ferrite magnetic powder obtained. Examples of these replacement elements are Co—Zn—Nb, Zn—Nb, Co, Zn, Nb, Co—Ti, Co—Ti—Sn, Co—Sn—Nb, Co—Zn—Sn—Nb, Co—Zn—Zr—Nb, and Co—Zn—Mn—Nb. To obtain such a hexagonal ferrite magnetic powder, it suffices to employ an additional hexagonal ferrite-forming component to adjust the coercive force. Examples of coercive force-adjusting components are divalent metal oxide components such as CoO and ZnO, and tetravalent metal oxide components such as TiO₂, ZrO₂, SnO₂ and MnO₂, and pentavalent metal oxide components such as Nb₂O₅. When employing such a coercive force-adjusting component, the content can be suitably determined to achieve the desired coercive force or the like.

The above starting material mixture can be obtained by weighing out and mixing the various components. Then, the starting material mixture is melted in a melting vat to obtain a melt. The melting temperature can be set based on the starting material composition, normally, to 1,000 to 1,500° C. The melting time can be suitably set for suitable melting of the starting material mixture.

### (2) Amorphous Rendering Step

Next, the melt obtained in the above step is discharged through an outlet provided in the bottom surface of the melting vat and supplied between dual rolls provided beneath the melting vat. The flow rate of the melt is desirably about 5 to 30 g/s when productivity and cooling efficiency are considered. The melt that has been supplied is cooled by rolling and rendered amorphous between the dual rolls. Dual rolls that satisfy (A) to (C) above are employed in the present invention.

(A) to (C) will be described in greater detail below.

Dual rolls with at least an outermost layer portion comprised of a material having a Young's modulus of equal to or higher than 500 GPa and a Rockwell hardness of equal to or higher than 85.0 HRA are employed. Just the outermost layer portion can be comprised of the above material, or the entire bodies, including the outermost layer portion, of the dual rolls, can be comprised of the above material. Generally, such materials are heavy, and dual rolls that are entirely comprised of the above material become extremely heavy and afford poor handling properties. Accordingly, when handling properties are taken into account, it is desirable to employ dual rolls with just the outermost layer portion comprised of the above material. In that case, the thickness of the outermost layer portion is equal to or greater than 5 mm, as set forth above. This is because resistance to scratching diminishes at a thickness of less than 5 mm. To further increase resistance to scratching, the thickness of the outermost layer portion is desirably equal to or greater than 15 mm, preferably equal to or greater than 20 mm. From the perspective of decreasing the overall weight of the rolls, a thickness of equal to or less than 50 mm is desirable.

A small diameter is desirable in the dual rolls from the perspective of increasing the nip pressure. However, the smaller the diameter, the greater the load per unit area and the more durability decreases, shortening the service lifetime of the rolls. In the present invention, it is desirable to employ dual rolls with a roll diameter of about 10 to 50 cm from the perspective of achieving both nip pressure and durability.

As set forth above, the Young's modulus of the material constituting the outermost layer portion is equal to or higher than 500 GPa. At below this level, the rolls deform greatly during rolling, making it difficult to achieve uniform cooling of the amorphous material. From the perspective of reducing roll deformation during rolling, the Young's modulus is desirably equal to or higher than 530 GPa, preferably equal to or higher than 600 GPa. The upper limit is not specifically limited. Considering the Young's modulus of available materials, the upper limit is about equal to or less than 680 GPa.

The Rockwell hardness of the material is equal to or higher than 85.0 HRA. At below this level, the generation of scratching makes it difficult to uniformly quench the amorphous material. From the perspective of inhibiting scratching, the Rockwell hardness is desirably equal to or higher than 90.0 HRA. The upper limit is not specifically limited. Considering the Rockwell hardness of available materials, the upper limit is about equal to or less than 96 HRA.

In the present invention, the “Young's modulus” is a value that is measured by a resonance method, and the “Rockwell hardness” is a value that is measured by a method in accordance with the Rockwell A hardness test method of CIS standard 027B for ultrahard alloys. Reference can be made to Examples described further below for details of these measurement methods.

As set forth above, the surface roughness of the milling rolls is equal to or less than 0.5 μm. The surface roughness refers to the average surface roughness (Ra). For example, it refers to the value measured at a cutoff value of 0.8 mm with a Surfcom made by Tokyo Seimitsu Co., Ltd. Reference can be made to Examples described further below for details of these measurement methods. From the perspective of inhibiting adhesion of the amorphous material, the surface roughness is desirably equal to or less than 0.25 μm, preferably equal to or less than 0.1 μm. The lower limit is, for example, about 0.001 μm, but is not specifically limited.

This material can be employed without any restrictions whatsoever so long as it has a Young's modulus of equal to or higher than 500 GPa and a Rockwell hardness of equal to or higher than 85.0 HRA. Taking ease of processing into account, an ultrahard alloy that can be processed into a desired shape by sintering is desirable. Ultrahard alloys with the above Young's modulus and Rockwell hardness are available as commercial products. Examples of commercial products are D10, 20, 25, 30, 40, T11L, T14L, and T17L made by Tungaloy Corporation; GTi05, MF07, MF10, MF20, MF30, SF10, TDA15, TF15, and HTi10 made by Mitsubishi Materials; and G3, G20, G30, and G40 made by Nippon Tungsten.

The milling rolls employed in the present invention can be fabricated by bonding a cylindrical member comprised of the above material over a shaft member comprised of steel cylinder (for example, a material such as SUJ2, SUS304, SUS420J, and SS). Alternatively, another layer can be inserted between the shaft member and the outermost layer portion. A layer comprised of the same steel material as the shaft member is desirable as the insertion layer.

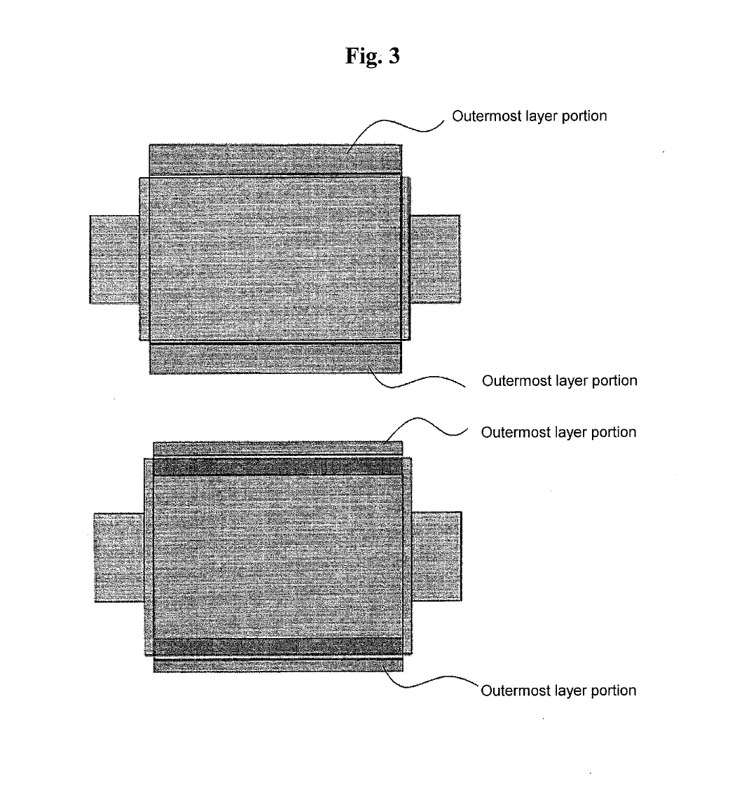

FIG. 3 shows specific examples (sectional views) of milling rolls of the above structure. The upper drawing in FIG. 3 is an example of a cylindrical member bonded to a shaft member. The lower drawing in FIG. 3 is an example of another layer inserted between the shaft member and the cylindrical member. However, the milling rolls employed in the present invention are not limited to the structures shown in FIG. 3. For example, as set forth above, milling rolls that are completely comprised of the above material can be employed. Milling rolls in the form of water-cooling rolls having an internal water-cooling structure can also be employed.

The surface of the rolls can be subjected to surface-smoothing processing such as polishing to achieve the above-stated surface roughness.

The starting material mixture that is supplied as a melt is rendered amorphous by roll cooling between milling rolls. As set forth above, it is desirable to thin the solidified melt at that time by rolling it between rolls to increase the uniformity of quenching. Thinly rolled, uniform quenching can be confirmed by the thickness of the amorphous material that is discharged from between the rolls. Specifically, the rolling conditions are desirably set so that the amorphous material is discharged from between the rolls as a thin strip equal to or less than 20 μm in thickness. Taking into account productivity and workability, the peripheral velocity of the rolls is desirably 10 to 40 m/s, and the pressure between rolls is desirably 0.25 to 1.5 kN/cm.

As set forth above, the saturation magnetization (as) of the amorphous material obtained in the above amorphous rendering step can serve as an index of uniform quenching. In the present invention, it is possible to obtain an amorphous material with a saturation magnetization of, for example, equal to or less than 0.3 A·m²/kg, desirably less than 0.2 A m²/kg. When the saturation magnetization of the amorphous material is equal to or less than 0.3 A·m²/kg, it is possible to obtain a final product in the form of hexagonal ferrite magnetic powder with the desired characteristics as a magnetic powder for use in magnetic recording media for high-density recording. The saturation magnetization is desirably as low as possible without dropping below, for example, 0.001 A·m²/kg, but is not specifically limited.

### (3) Crystallization Step

Following quenching, the amorphous material obtained is subjected to a heat treatment. This step causes hexagonal ferrite magnetic particles to precipitate. The heat treatment can be conducted by heating the amorphous material obtained by quenching to a prescribed temperature range and maintaining it at this temperature range. Since the particle size of the hexagonal ferrite magnetic powder that precipitates can be controlled by means of the above heating temperature (referred to as “crystallization temperature”, hereinafter) and heating period, it is desirable in the present invention to suitably select the heating temperature based on the target particle size. In order to obtain a microparticulate hexagonal ferrite magnetic powder, a crystallization temperature ranging from 580 to 760° C. is desirable. A rate of temperature rise to within the above temperature range of about 0.5 to 5° C./minute, for example, is suitable. The temperature is maintained within the above temperature range, for example, for a period of 0.5 to 24 hours, preferably 1 to 8 hours.

### (4) Particle Collecting Step

The product that has been heat treated in the above crystallization step comprises by-products such as a crystallized glass component and the like, in addition to precipitated hexagonal ferrite magnetic particles. Accordingly, after the crystallization step, a particle collecting step is conducted for collecting hexagonal ferrite magnetic particle from the heat treated product. The various treatments generally conducted in the glass crystallization method, such as acid treatment with heating, can be employed to remove the by-products and collect the hexagonal ferrite magnetic particles. The particles from which excess components have been removed by this treatment can be post-processed by washing with water, drying, and the like as needed to obtain hexagonal ferrite magnetic powder that is suited to magnetic recording media.

The present invention can yield a hexagonal ferrite magnetic powder having desirable characteristics as a magnetic powder in a magnetic recording medium for high-density recording by means of the above-described steps. The size of the particles in the hexagonal ferrite magnetic powder, expressed as the average plate diameter, desirably falls within a range of 15 to 35 nm from the perspective of achieving both dispersion and high-density recording. The term “average plate diameter” is the average value of the plate diameter as measured by randomly extracting 500 particles in a photograph taken by a transmission electron microscope. In the present invention, the term “average plate ratio” refers to the arithmetic average of the (plate diameter/plate thickness) of 500 particles randomly extracted as set forth above. The average plate ratio of the hexagonal ferrite magnetic powder obtained by the present invention is, for example, about 2 to 5. The particle size distribution of the hexagonal ferrite magnetic powder obtained can be evaluated by, for example, randomly extracting 500 particles from a photograph taken by a transmission electron microscope, determining the average value of the plate diameters measured (average plate diameter), calculating the standard deviation of the plate diameter of the 500 particles, and dividing it by the value of the average plate diameter (variation in particle diameter). The present invention can yield a hexagonal ferrite magnetic powder exhibiting a variation in particle diameter of equal to or less than 25 percent; for example, a particle size distribution of 15 to 25 percent.

Hexagonal Ferrite Magnetic Powder, Magnetic Powder for Magnetic Recording Medium, And Magnetic Recording Medium

The present invention further relates to a hexagonal ferrite magnetic powder prepared by the method of manufacturing of the present invention. Since the hexagonal ferrite magnetic powder of the present invention can exhibit characteristics desirable for magnetic material in high-density recording magnetic recording medium, it is desirably employed as a magnetic powder for magnetic recording medium.

Accordingly, the present invention can provide:

a magnetic material for magnetic recording medium, which is comprised of the hexagonal ferrite magnetic powder of the present invention; and

a magnetic recording medium comprising a magnetic layer containing a ferromagnetic powder and a binder on a nonmagnetic support, wherein the ferromagnetic powder comprises the hexagonal ferrite magnetic powder of the present invention.

An embodiment in which the hexagonal ferrite magnetic powder of the present invention is applied to a magnetic recording medium will be described below.

### Magnetic Layer

Details of the hexagonal ferrite magnetic powder employed in the magnetic layer, and the method of manufacturing the powder, are as set forth above. In addition to hexagonal ferrite magnetic powder, the magnetic layer comprises a binder. Examples of the binder comprised in the magnetic layer are: polyurethane resins; polyester resins; polyamide resins; vinyl chloride resins; styrene; acrylonitrile; methyl methacrylate and other copolymerized acrylic resins; nitrocellulose and other cellulose resins; epoxy resins; phenoxy resins; and polyvinyl acetal, polyvinyl butyral, and other polyvinyl alkyral resins. These may be employed singly or in combinations of two or more. Of these, the desirable binders are the polyurethane resins, acrylic resins, cellulose resins, and vinyl chloride resins. These resins may also be employed as binders in the nonmagnetic layer described further below. Reference can be made to paragraphs [0029] to [0031] in Japanese Unexamined Patent Publication (KOKAI) No. 2010-24113 for details of the binder. A polyisocyanate curing agent may also be employed with the above resins.

As needed, additives can be added to the magnetic layer. Examples of additives are: abrasives, lubricants, dispersing agents, dispersion adjuvants, antifungal agents, antistatic agents, oxidation inhibitors, solvents, and carbon black. These additives may be employed in the form of a commercial product suitably selected based on desired properties.

### Nonmagnetic Layer

Details of the nonmagnetic layer will be described below. The magnetic recording medium of the present invention may comprise a nonmagnetic layer comprising a nonmagnetic powder and a binder between the nonmagnetic support and the magnetic layer. Both organic and inorganic substances may be employed as the nonmagnetic powder in the nonmagnetic layer. Carbon black may also be employed. Examples of inorganic substances are metals, metal oxides, metal carbonates, metal sulfates, metal nitrides, metal carbides, and metal sulfides. These nonmagnetic powders are commercially available and can be manufactured by the known methods. Reference can be made to paragraphs [0036] to [0039] in Japanese Unexamined Patent Publication (KOKAI) No. 2010-24113 for details thereof.

Binder resins, lubricants, dispersing agents, additives, solvents, dispersion methods, and the like suited to the magnetic layer may be adopted to the nonmagnetic layer. In particular, known techniques for the quantity and type of binder resin and the quantity and type of additives and dispersing agents employed in the magnetic layer may be adopted thereto. Carbon black and organic powders can be added to the magnetic layer. Reference can be made to paragraphs [0040] to [0042] in Japanese Unexamined Patent Publication (KOKAI) No. 2010-24113 for details thereof.

### Nonmagnetic Support

A known film such as biaxially-oriented polyethylene terephthalate, polyethylene naphthalate, polyamide, polyamidoimide, or aromatic polyamide can be employed as the nonmagnetic support. Of these, polyethylene terephthalate, polyethylene naphthalate, and polyamide are preferred.

These supports can be corona discharge treated, plasma treated, treated to facilitate adhesion, heat treated, or the like in advance. The center average roughness, Ra, at a cutoff value of 0.25 mm of the nonmagnetic support suitable for use in the present invention preferably ranges from 3 to 10 nm.

### Layer Structure

As for the thickness structure of the magnetic recording medium of the present invention, the thickness of the nonmagnetic support preferably ranges from 3 to 80 μm. The thickness of the magnetic layer can be optimized based on the saturation magnetization of the magnetic head employed, the length of the head gap, and the recording signal band, and is normally 10 to 150 nm, preferably 20 to 120 nm, and more preferably, 30 to 100 nm. At least one magnetic layer is sufficient. The magnetic layer may be divided into two or more layers having different magnetic characteristics, and a known configuration relating to multilayered magnetic layer may be applied.

The nonmagnetic layer is, for example, 0.1 to 3.0 μm, preferably 0.3 to 2.0 μm, and more preferably, 0.5 to 1.5 μm in thickness. The nonmagnetic layer of the magnetic recording medium of the present invention can exhibit its effect so long as it is substantially nonmagnetic. It can exhibit the effect of the present invention, and can be deemed to have essentially the same structure as the magnetic recording medium of the present invention, for example, even when impurities are contained or a small quantity of magnetic material is intentionally incorporated. The term “essentially the same” means that the residual magnetic flux density of the nonmagnetic layer is equal to or lower than 10 mT, or the coercive force is equal to or lower than 7.96 kA/m (equal to or lower than 100 Oe), with desirably no residual magnetic flux density or coercive force being present.

Backcoat layer

A backcoat layer can be provided on the surface of the nonmagnetic support opposite to the surface on which the magnetic layer are provided, in the magnetic recording medium of the present invention. The backcoat layer desirably comprises carbon black and inorganic powder. The formula of the magnetic layer or nonmagnetic layer can be applied to the binder and various additives for the formation of the back layer. The back layer is preferably equal to or less than 0.9 μm, more preferably 0.1 to 0.7 μm, in thickness.

### Manufacturing Method

The process for manufacturing magnetic layer, nonmagnetic layer and backcoat layer coating liquids normally comprises at least a kneading step, a dispersing step, and a mixing step to be carried out, if necessary, before and/or after the kneading and dispersing steps. Each of the individual steps may be divided into two or more stages. All of the starting materials employed in the present invention, including the hexagonal ferrite magnetic powder, nonmagnetic powder, binders, carbon black, abrasives, antistatic agents, lubricants, solvents, and the like, may be added at the beginning of, or during, any of the steps. Moreover, the individual starting materials may be divided up and added during two or more steps. For example, polyurethane may be divided up and added in the kneading step, the dispersion step, and the mixing step for viscosity adjustment after dispersion. To achieve the object of the present invention, conventionally known manufacturing techniques may be utilized for some of the steps. A kneader having a strong kneading force, such as an open kneader, continuous kneader, pressure kneader, or extruder is preferably employed in the kneading step. Details of the kneading process are described in Japanese Unexamined Patent Publication (KOKAI) Heisei Nos. 1-106338 and 1-79274. The contents of these applications are incorporated herein by reference in their entirety. Further, glass beads may be employed to disperse the magnetic layer, nonmagnetic layer and backcoat layer coating liquids. Dispersing media with a high specific gravity such as zirconia beads, titania beads, and steel beads are also suitable for use. The particle diameter and filling rate of these dispersing media can be optimized for use. A known dispersing device may be employed. Reference can be made to paragraphs [0051] to [0052] in Japanese Unexamined Patent Publication (KOKAI) No. 2010-24113 for details of the method of manufacturing a magnetic recording medium.

The magnetic recording medium of the present invention set forth above can achieve high output due to the hexagonal ferrite magnetic powder of the present invention contained therein. Therefore, it is suitable for use as a high-density recording magnetic recording medium of which excellent electromagnetic characteristics are required.

### EXAMPLES

The present invention will be described in detail below based on examples. However, the present invention is not limited to the examples.

### Example 1

### (1) Preparation of Milling Rolls

An ultrahard alloy A (see Table 1) was bonded to the outer surface of a steel (SUJ2) shaft member by hot isostatic pressing (HIP processing) in a cylindrical shape 5 mm in thickness to prepare two rolls (20 cm in diameter) with the structure shown in the upper drawing of FIG. 3. Further, an ultrahard alloy was sintered into cylindrical members (20 cm in diameter) with hollow centers 35 mm in thickness. Subsequently, SUJ2 steel members were inserted into the hollows and bonded by cold fitting to prepare milling rolls of identical structure.

### (2) Preparation of Amorphous Material

Prescribed quantities of H₃BO₃, corresponding to B₂O₃, BaCO₃, corresponding to BaO, and Fe₂O₃ were weighed out to achieve, based on the oxides, 31.35 molar percent of B₂O₃, 36.68 molar percent of BaO, and 31.97 molar percent of Fe₂O₃ (with a Co-containing component, Zn-containing component, and Nb-containing component being added to the starting material mixture so that a portion of the Fe in the Fe₂O₃ was replaced with Co=0.5 at %, Zn=1.5 at %, and Nb=1 at %) and mixed in a mixer. The mixture was charged to a one-liter platinum crucible and melted by dielectric heating to raise the temperature at a rate of 5° C./min over three hours.

The temperature of the melt was further raised to 1,380° C., at which point a pouring outlet (discharge nozzle) provided on the bottom of the platinum crucible was heated while stirring the melt, and the melt was poured out in a rod shape at about 6 g/s.

The poured melt was caused to flow between rapidly rotating dual rolls (the rolls fabricated in (1) above were positioned opposite each other and a water-cooling mechanism was positioned within the shaft members) and quenched by rolling between the rolls to produce an amorphous material. The rolling conditions were set to the values indicated in Table 1. A portion of the amorphous material discharged as a thin strip-like substance from between the rolls was collected as a measurement sample and the thickness and saturation magnetization were measured by the following methods.

The saturation magnetization was measured using a vibrating sample magnetic fluxmeter (made by Toei-Kogyo Co., Ltd.) at a magnetic field strength of 15 kOe (1,194 kA/m). The thickness was measured with a contact-type micrometer, the Minicom, made by Tokyo Seimitsu Co., Ltd.

### (3) Preparation of Hexagonal Ferrite Magnetic Powder

To an electric furnace were charged 600 g of the amorphous material obtained in (2) above. The temperature was raised to 720° C. at 4° C./min., and then maintained there for five hours to cause hexagonal ferrite to crystallize (precipitate). Next, 600 g of the heat treated product was coarsely pulverized in a mortar, charged to a three-liter pot mill, and pulverized for four hours in a ball mill with 5 kg of φ5 mm Zr balls and 1.2 kg of pure water. The pulverized solution was then separated from the balls and charged to a five-liter stainless-steel beaker. The pulverized solution was mixed in a ratio of 3:1 (by weight) with a 30 weight percent acetic acid solution and stirred for two hours with the temperature regulated at 85° C. to conduct an acid treatment. Subsequently, decantation washing (washing with water) was repeatedly conducted and the product was dried, yielding hexagonal ferrite magnetic powder.

### Examples 2 to 13,

### Comparative Examples 1 to 9

With the exceptions that the material constituting the outermost layer portion (referred to as the “outermost layer portion material”, hereinafter), the thickness of the outermost layer portion, the roughness of the outermost layer portion (adjusted based on the conditions and the presence or absence of surface treatment), the rolling conditions, and the quantity of Fe₂O₃ in the starting material mixture were changed to the values indicated in Table 2, hexagonal ferrite magnetic powders were obtained by the same method as in Example 1. When the quantity of Fe₂O₃ in the starting material mixture was increased from 31.97 molar percent to the quantity indicated in Table 2, the H₃BO₃ corresponding to B₂O₃ was reduced by the amount of the increase.

Evaluation Methods

### (1) Young's Modulus of the Outermost Layer Portion Material

The Young's modulus of the outermost layer portion material was measured in Examples and Comparative Examples by the following method. The results are given in Table 1.

Test pieces (10 mm in width×60 mm in length×2 mm in thickness) were prepared from the same materials and under the same conditions (sintering conditions) as were employed to prepare the rolls in Examples and Comparative Examples, vibration was applied in the direction of thickness with a model JE-RT made by Nihon Techno-Plus Co., Ltd., and the Young's modulus was calculated from the frequency of resonance using equation (1) below.

E_{R}=0.9465×(M·f²/W)×(L/T)³×{1+6.59(T/L)²} (1)

(In the equation, E_{R}: Young's modulus (N/m²); M: weight of test piece (kg); f: resonance frequency (Hz); W: width of test piece (m); L: length of test piece (m); and T: thickness of test piece (m).)

### (2) Rockwell Hardness of the Outermost Layer Portion Material

The Rockwell hardness of the outermost layer portion materials in Examples and Comparative Examples was calculated by the following method in accordance with the Rockwall A hardness test method for ultrahard alloys of CIS standard 027B. The results are given in Table 1.

Test pieces (30 mm in width×30 mm in length×10 mm in thickness) were prepared from the same materials and under the same conditions (sintering conditions) as were employed to prepare the rolls in Examples and Comparative Examples. A Rockwell indenter (a round diamond cone with a tip angle of 120 degrees) was pressed into the surface of the test pieces that had been prepared with a load of 60 kg and the Rockwall hardness was calculated on the A scale using equation (2) below. The results are given in Table 1.

HR=a−b·h (2)

(In the equation, HR: Rockwell hardness (HRA); a, b: A scale values were employed; h: depth from reference plane.)

### (3) Roll Surface Roughness

Excluding scratches 2.5 mm in measured length (in the direction of width of the roll) that could be visually confirmed, the surface of the roll was measured at a cutoff value of 0.8 mm with a Surfcom made by Tokyo Seimitsu Co., Ltd. and the surface roughness of the dual rolls employed in Examples and Comparative Examples was measured. The results are given in Table 2.

### (4) Scratch Resistance and Amount of Adhesion of Amorphous Material to the Rolls

Following the first cooling by rolling, the surface of the roll was observed and the presence or absence of scratching and adhesion of the amorphous material were visually determined. Those rolls exhibiting no scratching are denoted by ◯ and those rolls exhibiting several scratches are denoted by Δ, X, XX (increasing number of scratches in the order Δ->X->XX). Those rolls exhibiting almost no adhesion of amorphous material are denoted by ◯, and those exhibiting adhesion by several thin pieces of amorphous material are denoted by X in Table 2.

### (5) Roll Durability

Roll cooling was continuously repeated and the time required for scratches to form over the entire outer surface of the rolls and for use to become difficult was determined. Those for which this time was equal to or more than 1,000 hours are denoted as ◯, those with times of equal to or more than 100 hours but less than 1,000 hours are denoted as Δ, those with times of equal to or more than 10 hours but less than 100 hours are denoted as X, and those with times of less than 10 hours are denoted as XX in Table 2.

TABLE 1

| | Young's modulus (GPa) | Rockwell hardness (HRA) |
|---|---|---|
| Ultrahard alloy A | 630 | 93.2 |
| Ultrahard alloy B | 640 | 94.0 |
| Ultrahard alloy C | 540 | 87.0 |
| Ultrahard alloy D | 460 | 83.8 |
| CrN | Less than 500 GPa^{note 1)} | 93.0 |
| Diamond-like- | 600 | Measurement was |
| carbon (DLC) | | impossible.^{note 2)} |
| Hard chromium | Less than 500 GPa^{note 1)} | 84.0 |
| SUJ2 | 210 | 81.0 |

^{note 1)}Due to material properties, it was not possible to form a test piece with a thickness permitting measurement of Young's modulus. Accordingly, the Young's modulus was determined not to satisfy 500 GPa.
^{note 2)}Due to measurement principles, measurement was impossible because a diamond indenter was employed.

TABLE 2

| | | | | | | Content of | | |
|---|---|---|---|---|---|---|---|---|
| | | | | | | Fe₂O₃ in | | |
| | | | Rolling condition | | | the | | |
| | | | Peripheral | Pressure | Surface | starting | Amorphous material | |
| | Outermost layer | | velocity of | between | roughness | material | Saturation | |
| | portion of rolls | | rotating | rolls | of rolls | mixture | magnetization | Thickness |
| | Material | Thickness | rolls (m/s) | (kN/cm) | (μm) | (molar %) | (A · m²/kg) | (μm) |
| Ex. 1 | Ultrahard | 5 mm | 20 | 0.5 | 0.08 | 31.97 | 0.15 | 15 |
| | alloy A | | | | | | | |
| Ex. 2 | Ultrahard | 10 mm | 20 | 0.5 | 0.08 | 31.97 | 0.15 | 15 |
| | alloy A | | | | | | | |
| Ex. 3 | Ultrahard | 20 mm | 20 | 0.5 | 0.08 | 31.97 | 0.10 | 10 |
| | alloy A | | | | | | | |
| Ex. 4 | Ultrahard | 35 mm | 20 | 0.5 | 0.08 | 31.97 | 0.11 | 10 |
| | alloy A | | | | | | | |
| Ex. 5 | Ultrahard | 35 mm | 20 | 0.5 | 0.08 | 31.97 | 0.05 | 8 |
| | alloy B | | | | | | | |
| Ex. 6 | Ultrahard | 35 mm | 20 | 0.5 | 0.08 | 31.97 | 0.12 | 15 |
| | alloy C | | | | | | | |
| Ex. 7 | Ultrahard | 35 mm | 20 | 1.0 | 0.08 | 31.97 | 0.05 | 5 |
| | alloy A | | | | | | | |
| Ex. 8 | Ultrahard | 35 mm | 20 | 0.25 | 0.08 | 31.97 | 0.25 | 23 |
| | alloy A | | | | | | | |
| Ex. 9 | Ultrahard | 35 mm | 10 | 0.5 | 0.08 | 31.97 | 0.20 | 22 |
| | alloy A | | | | | | | |
| Ex. 10 | Ultrahard | 35 mm | 5 | 0.5 | 0.08 | 31.97 | 0.22 | 24 |
| | alloy A | | | | | | | |
| Ex. 11 | Ultrahard | 35 mm | 20 | 0.5 | 0.08 | 34.90 | 0.15 | 13 |
| | alloy A | | | | | | | |
| Ex. 12 | Ultrahard | 35 mm | 20 | 0.5 | 0.08 | 38.4 | 0.18 | 15 |
| | alloy A | | | | | | | |
| Ex. 13 | Ultrahard | 35 mm | 20 | 0.5 | 0.008 | 31.97 | 0.11 | 10 |
| | alloy A | | | | | | | |
| Comp. Ex. 1 | Ultrahard | 1 mm | 20 | 0.5 | 0.08 | 31.97 | 0.20 | 20 |
| | alloy A | | | | | | | |
| Comp. Ex. 2 | CrN | 5 μm | 20 | 0.5 | 0.08 | 31.97 | 0.31 | 25 |
| Comp. Ex. 3 | DLC | 5 μm | 20 | 0.5 | 0.08 | 31.97 | 0.33 | 25 |
| Comp. Ex. 4 | SUJ2 | 35 mm | 20 | 0.5 | 0.08 | 31.97 | 0.35 | 25 |
| Comp. Ex. 5 | Hard | 200 μm | 20 | 0.5 | 0.08 | 31.97 | 0.25 | 23 |
| | chromium | | | | | | | |
| | plating | | | | | | | |
| Comp. Ex. 6 | Ultrahard | 35 mm | 20 | 0.5 | 0.08 | 31.97 | 0.20 | 20 |
| | alloy D | | | | | | | |
| Comp. Ex. 7 | SUJ2 | 35 mm | 20 | 0.5 | 0.08 | 31.97 | 0.50 | 25 |
| Comp. Ex. 8 | SUJ2 | 35 mm | 20 | 0.5 | 0.08 | 38.40 | 0.55 | 25 |
| Comp. Ex. 9 | Ultrahard | 35 mm | 20 | 0.5 | 0.15 | 31.97 | 0.11 | 10 |
| | alloy A | | | | | | | |

| | | Amount of adhesion of amorphous | |
|---|---|---|---|
| | Scratch resistance | material to the rolls | Roll durability |
| Ex. 1 | ∘ | ∘ | ∘ |
| Ex. 2 | ∘ | ∘ | ∘ |
| Ex. 3 | ∘ | ∘ | ∘ |
| Ex. 4 | ∘ | ∘ | ∘ |
| Ex. 5 | ∘ | ∘ | ∘ |
| Ex. 6 | ∘ | ∘ | ∘ |
| Ex. 7 | ∘ | ∘ | ∘ |
| Ex. 8 | ∘ | ∘ | ∘ |
| Ex. 9 | ∘ | ∘ | ∘ |
| Ex. 10 | ∘ | ∘ | ∘ |
| Ex. 11 | ∘ | ∘ | ∘ |
| Ex. 12 | ∘ | ∘ | ∘ |
| Ex. 13 | ∘ | ∘ | ∘ |
| Comp. Ex. 1 | x | ∘ | x |
| Comp. Ex. 2 | xx | ∘ | xx |
| Comp. Ex. 3 | xx | ∘ | xx |
| Comp. Ex. 4 | xx | ∘ | xx |
| Comp. Ex. 5 | x | ∘ | x |
| Comp. Ex. 6 | Δ | ∘ | Δ |
| Comp. Ex. 7 | xx | ∘ | xx |
| Comp. Ex. 8 | xx | ∘ | xx |
| Comp. Ex. 9 | Δ | x | Δ |

Based on the results in Table 2, the use of milling rolls satisfying (A) to (C) above was confirmed to permit uniform quenching of the amorphous material with high production stability (roll durability).

The hexagonal ferrite magnetic powder obtained in the present invention is suitable as a magnetic powder in magnetic recording media for ultra high-density recording.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any Examples thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

What is claimed is:

1. A method of manufacturing a hexagonal ferrite magnetic powder comprising:
melting in a melting vat a starting material mixture comprising a glass-forming component and a hexagonal ferrite-forming component;
discharging a melt prepared through an outlet provided in the bottom surface of the melting vat and supplying it between a pair of rotating milling rolls positioned beneath the melting vat;
discharging an amorphous material from between the rolls by roll quenching the melt that has been supplied between the milling rolls;
subjecting the amorphous material to heat treatment to cause hexagonal ferrite magnetic particles to precipitate; and
collecting the hexagonal ferrite magnetic particles precipitated from a substance obtained by the heat treatment, wherein
at least an outermost layer portion of the milling rolls is comprised of a material with a Young's modulus of equal to or higher than 500 GPa and a Rockwell hardness of equal to or higher than 85.0 HRA,
the outermost layer portion has a thickness of equal to or greater than 5 mm, and
the milling rolls have a surface roughness of equal to or less than 0.5 μm.

2. The method of manufacturing a hexagonal ferrite magnetic powder according to claim 1, wherein a pressure between the milling rolls ranges from 0.25 to 1.5 kN/cm.

3. The method of manufacturing a hexagonal ferrite magnetic powder according to claim 1, wherein a peripheral velocity of the milling rolls ranges from 10 to 40 m/s.

4. The method of manufacturing a hexagonal ferrite magnetic powder according to claim 1, wherein a diameter of the milling rolls ranges from 10 to 50 cm.

5. The method of manufacturing a hexagonal ferrite magnetic powder according to claim 1, wherein a saturation magnetization of the amorphous material discharged from between the rolls is equal to or greater than 0.3 A·m²/kg.

6. The method of manufacturing a hexagonal ferrite magnetic powder according to claim 1, wherein the amorphous material is discharged from between the rolls as a thin strip equal to or less than 20 μm in thickness.

7. The method of manufacturing a hexagonal ferrite magnetic powder according to claim 1, wherein the starting material mixture comprises equal to or higher than 30 molar percent of a Fe₂O₃ component a portion of which may be replaced with a coercive force-adjusting component.

8. The method of manufacturing a hexagonal ferrite magnetic powder according to claim 1, wherein the melt is discharged through an outlet at a flow rate ranging from 5 to 30 g/s.

9. The method of manufacturing a hexagonal ferrite magnetic powder according to claim 1, wherein the hexagonal ferrite magnetic powder is a barium ferrite magnetic powder.

10. A hexagonal ferrite magnetic powder prepared by the method of manufacturing according to claim 1.

11. A magnetic recording medium comprising a magnetic layer containing a ferromagnetic powder and a binder on a nonmagnetic support, wherein the ferromagnetic powder comprises the hexagonal ferrite magnetic powder according to claim 10.
